(19) United States
(12) Patent Application Publication
(10) Pub. No.: US 2026/0248107 A1
(43) Pub. Date: Aug. 27, 2026

(54) SYSTEM AND METHOD FOR MARKERLESS BIOMECHANICS OF EQUINES

(71) Applicant: Southwest Research Institute, San Antonio, TX (US)

(72) Inventors: Omar D. MEDJAOURI, Boston, MA (US); Sarah K. SHAFFER, San Antonio, TX (US); Brian C. SWENSON, San Antonio, TX (US)

(21) Appl. No.: 19/546,897

(22) Filed: Feb. 23, 2026

Related U.S. Application Data
(60) Provisional application No. 63/763,038, filed on Feb. 25, 2025.

(51) Int. Cl. A01K 29/00; A61D 99/00; G06T 7/246; G06T 7/73; G06T 7/80; H04N 23/90

(52) U.S. Cl. CPC A01K 29/005; A61D 99/00; G06T 7/248; G06T 7/74; G06T 7/80; H04N 23/90; G06T 2207/10016; G06T 2207/20084; G06T 2207/30241

(57) ABSTRACT

In an approach to markerless biomechanics of equines, a method includes: receiving a plurality of camera views from a plurality of markerless video cameras; calibrating the plurality of markerless video cameras to create camera calibration information for each of the plurality of markerless video cameras; predicting a two-dimensional location of skeletal landmarks in each of the plurality of camera views; performing triangulation to reconstruct a three-dimensional location of each predicted landmark based on the predicted two-dimensional location of the skeletal landmarks and the camera calibration information; regionally scaling a musculoskeletal model using the three-dimensional location of each predicted landmark; and performing inverse kinematics on the musculoskeletal model to produce kinematic trajectories.

### CROSS-REFERENCE TO RELATED APPLICATIONS

The present application claims the benefit of the filing date of U.S. Provisional Application Ser. No. 63/763,038, filed Feb. 25, 2025, the entire teachings of which application is hereby incorporated herein by reference.

### FIELD

The present disclosure relates generally to equine biomechanics and, more particularly, to a system and method for markerless biomechanics of equines.

### BACKGROUND

The ability to quantify equine kinematics is essential for clinical evaluation, research, and performance feedback. Equine gait data can be used to identify lameness and provide sports feedback. However, most tools that measure how a horse moves are time-consuming to use and require specialized expertise and equipment. A need remains to provide a motion capture system more specifically for equines that starts with a two-dimensional (2D) video of the equine and from that image sequence, provides three-dimensional (3D) kinematic data.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system for markerless biomechanics of equines consistent with the present disclosure.

FIG. 2 is an example of 2D marker detection on a horse, consistent with the present disclosure.

FIG. 3 is an example of 3D triangulation for optimal location of landmarks on a horse, consistent with the present disclosure.

FIG. 4 is an example of model scaling on a horse based on the 3D information from FIG. 3, consistent with the present disclosure.

FIG. 5 is an example of inverse kinematics on a horse, consistent with the present disclosure.

FIG. 6 is an example of kinematic data for a horse based on the inverse kinematics of FIG. 5, consistent with the present disclosure.

FIG. 7 is a flowchart diagram depicting operations for one illustrative example embodiment of the process for markerless biomechanics of equines, on the system of FIG. 1, consistent with the present disclosure.

### DETAILED DESCRIPTION

The present invention provides a system and method for establishing 3D locations of physical landmarks on horses and the optimization of an equine biomechanical model to produce kinematic information in a multi-camera capture volume. Reference to physical landmarks on the equine is reference to anatomic locations, such as the carpus joint, fetlock joint, point of the hip, poll (a location between the ears) and jaw. The process preferably combines machine learning, pose estimation, multi-view geometry, and horse biomechanics.

The process initially relies upon a plurality a cameras, namely two or more cameras, arranged to view a space of interest. Reference to a space of interest is reference to the field of view of the cameras that is to be captured. For example, cameras may be positioned around the periphery of a riding arena and the space of interest would be the arena. The cameras are also preferably calibrated so that their relative poses (to each other or to a defined fixed reference frame) and intrinsic properties are known. The intrinsic properties of the camera are referenced to, e.g., the focal length or distortion parameters of the camera.

The process requires a model for detecting and estimating the 2D pose of horses as well as a full equine biomechanical model. The full equine musculoskeletal model is a representation of the horse's musculoskeletal system; the skeletal system is represented by rigid bodies. Currently, this model is preferably built in the OpenSim software platform, but it may be built in other software.

During development of the system, equine data sets consisting of images labeled with the location of skeletal landmarks and a region of interest around the horse are used. Preferably, labeled images will be from sources with various types of breeds, sizes, ages, and colors of horses with various backgrounds. Labeled datasets can be created multiple ways, which could include tracking traditional marker-based motion capture markers and projecting them into a image or having a human manually annotate the landmarks. This data is used as training data for the neural network that identifies skeletal landmarks on unlabeled images. An open-source equine biomechanical model (rigid-body model) was used as a base model. Joint range of motion (ROM) was restricted to within physiological limits or using best engineering judgement. Virtual markers corresponding to the defined landmark set were fixed on the model.

The first step of the process is to detect horses present in each camera view. As used herein, a camera view determines the perspective and framing of a scene and includes a plurality of video frames. This is preferably accomplished with a computer vision model trained to detect various entities within images. The computer vision model refers to a neural network which is capable of taking 2D images of horses and producing 2D bounding boxes for each horse present. These results are then used in the next step of the process. A pretrained version of the standard MaskRCNN object detection network may be used to determine the initial (first frame) horse region of interest (ROI).

The second step of the process is to locate the 2D locations of physical landmarks on the detected horses, otherwise known as its pose, in each of the camera views. This is preferably performed using a computer vision model that has been trained on collected data with human annotations. The computer vision model relies upon a relatively large dataset of multi-camera video of horses. This data may then be manually labeled, automatically labeled by using a partially trained version of the model to assist with human annotation, or both manually and automatically labeled. The data is then split into train, validation, and test splits following standard neural network training protocols.

The third step of the process is to take the set of 2D horse poses estimated in the second step and use a triangulation method to fuse them into a 3D horse pose. In an embodiment, the triangulation method may use an algorithm called random sample consensus (RANSAC). This algorithm uses pairs of 2D points from different camera views and attempts to select the best pair by measuring error between a resultant 3D point and the corresponding 2D point in each camera view. Accordingly, the triangulation method uses multi-view camera geometry to produce a 3D horse pose that best fits the estimated 2D poses for each camera. This process effectively filters the raw 2D poses and is performed repeatedly to produce 3D horse poses for each frame of the captured videos.

In the final step, the 3D horse poses produced by the triangulation method are used to fit an equine biomechanical model through an inverse kinematics optimization. Inverse kinematics is reference to the process that minimizes the distance between experimental marker locations (predicted by the computer vision software) and virtual markers on the musculoskeletal model. As those of skill in the art will recognize, inverse kinematics can be achieved with experimental markers that are physical objects attached to the subject's body (i.e., small reflective balls) and one tracks the locations of the markers with the camera system. In the disclosed system, however, experimental markers that were predicted by the previously described neural networks are used rather than physical markers on the horse. Preferably the inverse kinematics optimization herein is accomplished using the OpenSim platform and it is contemplated that one can utilize other software for kinematic optimization. The OpenSim platform inverse kinematics tool steps through each time frame of experimental data and positions the model in a pose that “best matches” experimental marker and coordinate data for that time step. This “best match” is the pose that minimizes a sum of weighted squared errors of markers and/or coordinates. The optimization herein then constrains the 3D horse poses to those which are biomechanically accurate in terms of both segment lengths and joint degrees of freedom. The biomechanical model may then be used to export a full set of equine kinematics (biomechanical states of the equine).

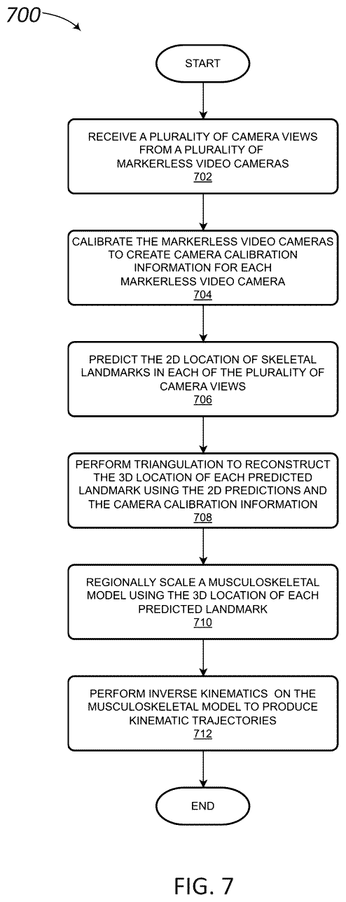

The process is further described in FIG. 7.

It can therefore be appreciated that the present invention stands directed at a system and method for generating equine biomechanics comprising: (a) providing a plurality of cameras directed to an equine and securing two-dimensional images of said equine and estimating two-dimensional locations of selected physical landmarks on the equine; (b) triangulating the two-dimensional locations of selected physical landmarks into three-dimensions; and (c) fitting the three-dimensional location of selected physical landmarks of the equine into an equine biomechanical model using kinematic optimization.

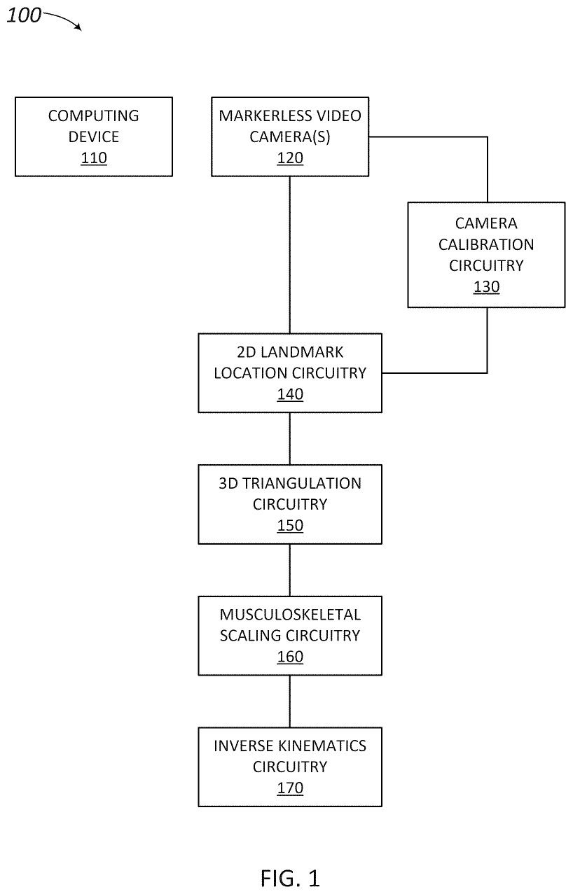

FIG. 1 is a functional block diagram illustrating a system 100 for markerless biomechanics of equines consistent with the present disclosure. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

System 100 includes computing device 110. In an embodiment, computing device 110 can be a standalone computing device, a management server, a web server, a mobile computing device, or any other electronic device or computing system capable of receiving, sending, and processing data. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within system 100.

System 100 includes a plurality of markerless video cameras 120 configured to capture a plurality of camera views of a subject horse. In order to capture camera views sufficient for markerless biomechanics of equines, at least two video cameras 120 are required to capture video of the horse. Camera calibration circuity 130 is configured to obtain camera calibration information for each of the markerless video cameras 120.

System 100 also includes 2D landmark location circuitry 140, 3D triangulation circuitry 150, musculoskeletal scaling circuitry 160, and inverse kinematics circuitry 170.

In an embodiment, the 2D landmark location circuitry 140 may include a convolutional neural network (CNN) configured to predict a two-dimensional location of skeletal landmarks in each of the plurality of camera views. In some other embodiments, other types of neural networks may be used to predict the two-dimensional location of skeletal landmarks in each of the plurality of camera views.

In an embodiment, the 3D triangulation circuitry 150 may include circuitry to perform a RANSAC algorithm to perform triangulation to reconstruct a three-dimensional location of each predicted landmark based on a predicted two-dimensional location of the skeletal landmarks. In some other embodiments, other circuitry may be included to perform the triangulation to reconstruct the three-dimensional location of each predicted landmark based on the predicted two-dimensional location of the skeletal landmarks.

In an embodiment, the musculoskeletal scaling circuitry 160 is configured to regionally scale a musculoskeletal model using the three-dimensional location of each of the predicted landmarks.

In an embodiment, the inverse kinematics circuitry 170 is configured to produce kinematic trajectories from the musculoskeletal model.

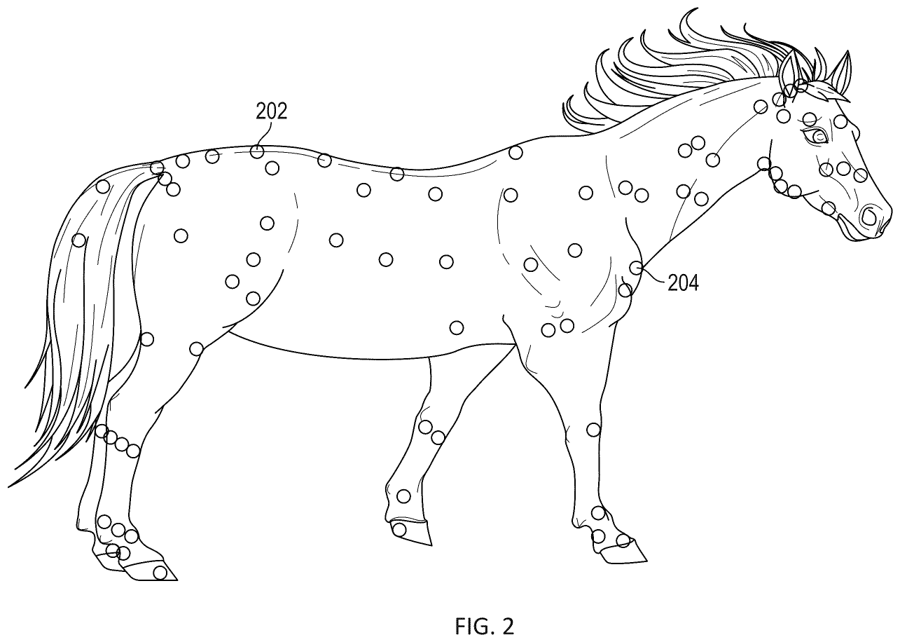

FIG. 2 is an example of 2D marker detection on a horse, consistent with the present disclosure. The video from the plurality of markerless video cameras 120 is synchronized and landmarks 202 and 204 are identified in each video frame from all cameras. The 2D location of skeletal landmarks 202 and 204 are identified in each camera view by a CNN.

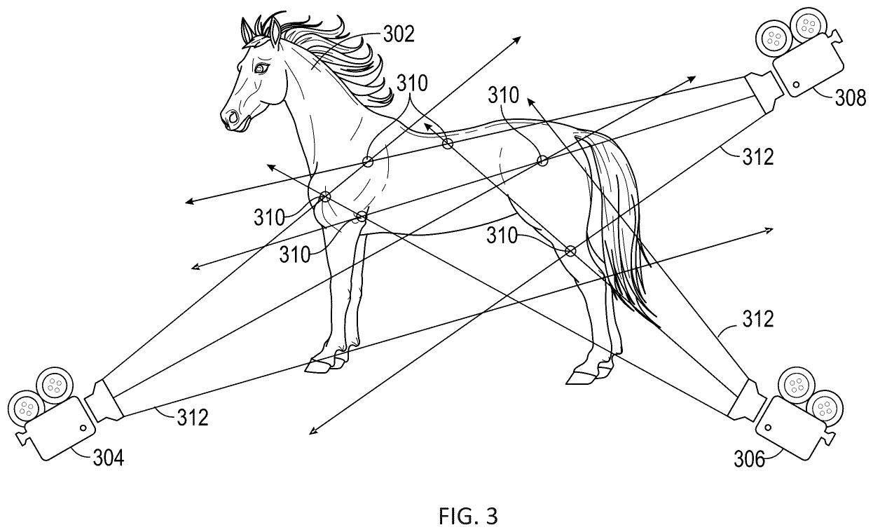

FIG. 3 is an example of 3D triangulation for optimal location of landmarks on a horse, consistent with the present disclosure. In the 3D triangulation process, optimal location landmarks 310 on a 3D drawing are based on the 2D detections and the camera information from the camera calibration circuitry 130.

In FIG. 3, three markerless video cameras, camera-1 304, camera-2 306, and camera-3 308 are positioned to capture three different camera views of horse 302. The system determines the optimal location landmarks 310 on a 3D drawing of the horse 302 by the intersection of rays 312 projected from the camera-1 304, the camera-2 306, and the camera-3 308.

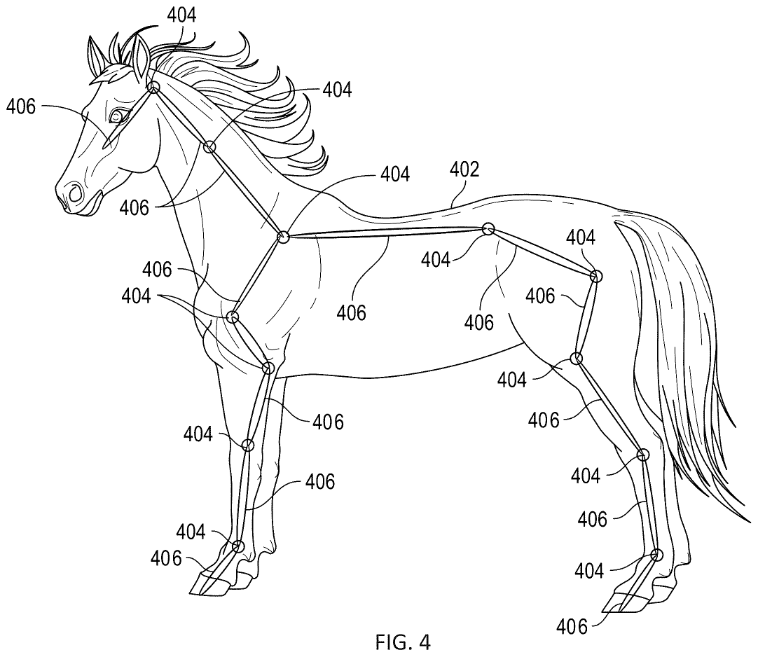

FIG. 4 is an example of model scaling on a horse 402 based on the 3D information from FIG. 3, consistent with the present disclosure. In the example of FIG. 4, regional body segments (between the dots 404) are scaled to fit the subject horse 402 based on the 3D information as determined in FIG. 3. The dots 404 represent joints that have some number of degrees of freedom. The distance between the joints, represented by arcs 406, is used to scale the horse 402 accordingly.

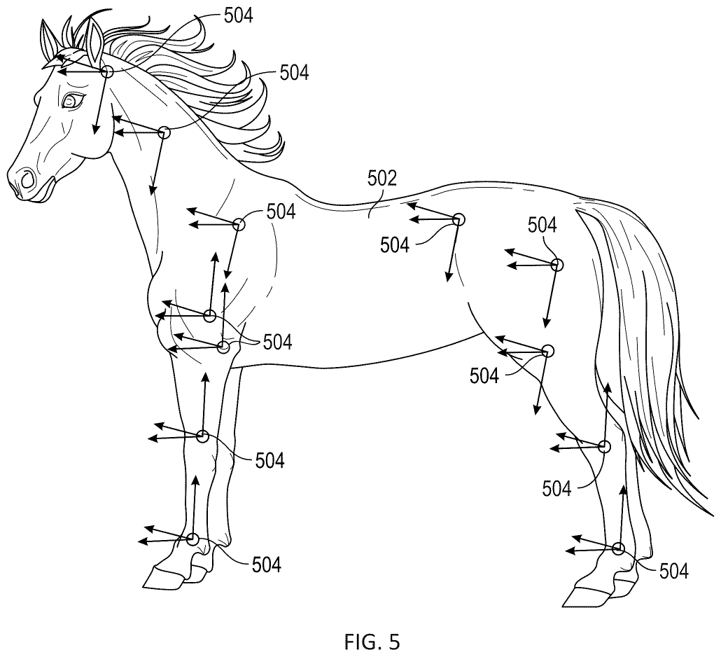

FIG. 5 is an example of inverse kinematics on a horse 502, consistent with the present disclosure. The example of FIG. 5 demonstrates the fitting of the generated landmarks to fixed marker locations from the ground truth horse model.

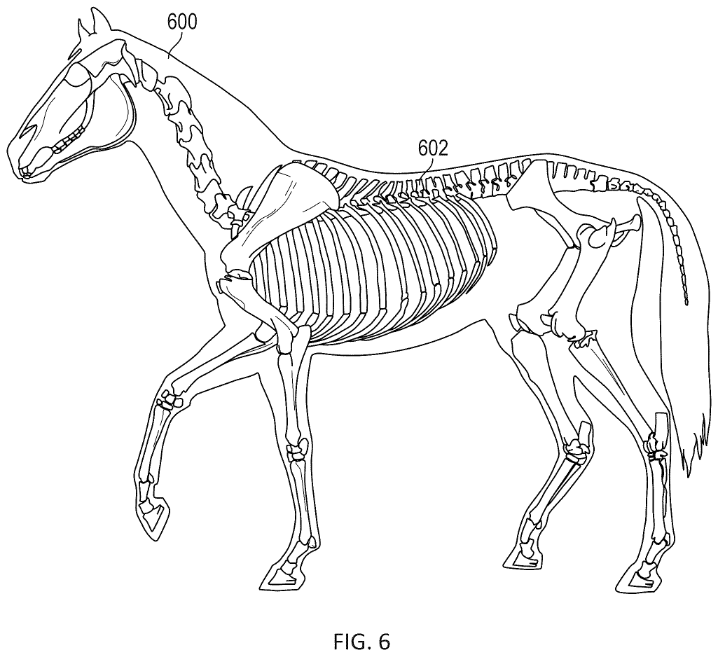

FIG. 6 is an example of kinematic data for a horse 600 based on the inverse kinematics of FIG. 5, showing a clear overlay of a skeleton shape 602 on horse 600. The inverse kinematics data represents an angle versus time for the joints. In the disclosed system, the full body data is pulled out in 3D.

FIG. 7 is a flowchart diagram depicting operations for one illustrative example embodiment of the process 700 for markerless biomechanics of equines, on the system of FIG. 1, consistent with the present disclosure. It should be appreciated that embodiments of the present disclosure provide at least for markerless biomechanics of equines. However, FIG. 7 provides only an illustration of one implementation and does not imply any limitations with regard to the environments in which different embodiments may be implemented. Many modifications to the depicted environment may be made by those skilled in the art without departing from the scope of the disclosure as recited by the claims.

Process 700 includes receiving a plurality of camera views from a plurality of markerless video cameras (operation 702). In the illustrated example embodiment, multi-camera video data is received from a plurality of markerless video cameras.

Process 700 includes calibrating the markerless video cameras to create camera calibration information for each of the markerless video cameras (operation 704). In an embodiment, the camera calibration information includes at least one of intrinsic parameters and extrinsic parameters. In an embodiment, the intrinsic parameters of each of the plurality of markerless video cameras may include at least one of an intrinsic matrix (K) and a distortion coefficients (d). The K matrix consists of the geometric properties of the camera, including the vertical and horizontal focal length and the principal point offset. The distortion coefficients represent the known deviation from rectilinear projection.

In an embodiment, the extrinsic parameters of each of the plurality of markerless video cameras may include at least one of a rotation matrix (R) and a translation vector (t). The rotation matrix (R) and translation vector (t) represent the transformation from the world coordinate system to a camera-centric coordinate system. In other words, they represent the orientation and location of the camera with respect to the global coordinate system.

Process 700 includes predicting the 2D location of skeletal landmarks in each of the plurality of camera views (operation 706). In operation 706, the process 700 first detects horses present in each camera view. This is done with a computer vision model trained to detect various entities within images. These results are then used to locate the 2D locations of physical landmarks on detected horses, otherwise known as its pose, in each of the camera views. This is performed using a CNN that has been trained on labeled image data, as discussed earlier.

In an embodiment, the HRNet (High-Resolution Network) architecture, a deep learning framework that maintains high-resolution representations throughout the entire network process by connecting multi-resolution convolution streams in parallel and repeatedly exchanging information across them, was selected for the neural network that predicts the 2D location of skeletal markers. This architecture consists of multiple parallel branches at different feature resolutions, thus preserving fine-grain visual features without sacrificing performance.

The network produces 2D pose predictions in the form of multi-channel heatmaps with each channel containing a 2D distribution of the likelihood a specific keypoint is present at a given pixel coordinate. Predicted 2D keypoint locations are then obtained by locating the maximum activation within each channel.

It should be noted that although the example embodiment described above is one architecture for predicting the 2D location of skeletal landmarks, in other embodiments, other neural network architectures may be used as would be known to one skilled in the art.

Process 700 includes performing triangulation to reconstruct the 3D location of each predicted landmark using the 2D predictions and the camera calibration information (operation 708). In operation 708, the process 700 takes the set of 2D pose predictions estimated in operation 706 and uses a triangulation method to fuse them into a 3D horse pose. This triangulation method features a random sample and consensus algorithm and uses camera geometry to produce a 3D horse pose that best fits the estimated 2D poses for each camera. This process effectively filters the raw 2D poses and is performed repeatedly to produce 3D horse poses for each frame of the captured videos.

In an embodiment, the triangulation procedure consists of selecting two-dimensional points from different camera views of the of the plurality of camera views, measuring an error between a resulting three-dimensional point and the two-dimensional point, and selecting the two-dimensional point and the three-dimensional point having a lowest error.

In an embodiment, the triangulation procedure uses a RANSAC algorithm which takes pairs of 2D skeletal markers and computes 3D rays originating at their respective source camera using the intrinsic parameters and the extrinsic parameters of each camera, obtained in operation 704. These ray pairs are used to obtain candidate 3D locations for each skeletal marker by locating the nearest point to both rays. The RANSAC algorithm calculates the number of inliers and outliers for each candidate 3D location and selects the candidates which minimize the number of outliers, thus reducing the impact of spurious 2D marker predictions. As used herein, the terms “inliers” and “outliers” are in reference to the set of lines which are considered “valid” based on their distance to the estimated 3D location of an individual skeleton landmark. During the RANSAC process, the distance between the rays cast from each camera and the estimated 3D location is computed and determine a distance threshold which is used to determine the likelihood that the estimated 3D location is correct. In an embodiment, the distance threshold is a configurable parameter in the system. In some embodiments, the system may include default values for the distance threshold. Inliers are rays within the distance threshold and outliers are rays with distance that exceeds the threshold. The resulting 3D marker locations are then reprojected into each camera view and used to help derive the horse ROI on the following frame. This process is repeated until the entire capture (all video frames) is processed.

Process 700 includes regionally scaling a musculoskeletal model using the 3D location of each predicted landmark (operation 710). For all calculations, the musculoskeletal model is regionally scaled using the predicted landmark locations. For example, to scale the head the system may use predicted 3D distances between markers on the head and adjust the size of the head segment using the corresponding virtual markers on the musculoskeletal model (e.g., make distances match). Each landmark is associated with a fixed virtual marker on the musculoskeletal model, e.g., the OpenSim model, allowing for regional scaling (e.g., the head is scaled with landmarks on the head) and inverse kinematics. This 3D pose estimate starts the inverse kinematics pipeline (see operation 712) using the 3D keypoint location to scale the equine musculoskeletal model and the relative confidence of each keypoint prediction to set initial weights for the inverse kinematics.

Process 700 includes performing inverse kinematics on the musculoskeletal model to produce kinematic trajectories (operation 712). In operation 712, the process 700 uses the 3D horse poses produced by the triangulation method to fit an equine biomechanical model through an inverse kinematics optimization. This optimization constrains the 3D horse poses to those which are biomechanically accurate in terms of both segment lengths and joint degrees of freedom. The biomechanical model is then used to export a full set of kinematics that can be used for further analysis.

According to one aspect of the disclosure, there is thus provided a method of markerless biomechanics of equines. The method includes: receiving a plurality of camera views from a plurality of markerless video cameras; calibrating the plurality of markerless video cameras to create camera calibration information for each of the plurality of markerless video cameras; predicting a two-dimensional location of skeletal landmarks in each of the plurality of camera views; performing triangulation to reconstruct a three-dimensional location of each predicted landmark based on the predicted two-dimensional location of the skeletal landmarks and the camera calibration information; regionally scaling a musculoskeletal model using the three-dimensional location of each predicted landmark; and performing inverse kinematics on the musculoskeletal model to produce kinematic trajectories.

According to another aspect of the disclosure there is thus provided a system for markerless biomechanics of equines. The system includes: a plurality of markerless video cameras; camera calibration circuitry; two-dimensional landmark location circuitry; three-dimensional triangulation circuitry; musculoskeletal scaling circuitry; inverse kinematics circuitry; and a computing device. The computing device is configured to: receive a plurality of camera views from the plurality of markerless video cameras; calibrate the plurality of markerless video cameras using the camera calibration circuitry to create camera calibration information for each of the plurality of markerless video cameras; predict a two-dimensional location of skeletal landmarks in each of the plurality of camera views using the two-dimensional landmark location circuitry; perform triangulation to reconstruct a three-dimensional location of each predicted landmark based on the predicted two-dimensional location of the skeletal landmarks and the camera calibration information using the three-dimensional triangulation circuitry; regionally scale a musculoskeletal model using the three-dimensional location of each predicted landmark; and perform inverse kinematics on the musculoskeletal model to produce kinematic trajectories.

According to yet another aspect of the disclosure, there is thus provided a method of markerless biomechanics of equines. The method includes: receiving a plurality of camera views from a plurality of markerless video cameras; calibrating the plurality of markerless video cameras to create camera calibration information for each of the plurality of markerless video cameras, wherein the camera calibration information includes at least one of intrinsic parameters and extrinsic parameters; predicting a two-dimensional location of skeletal landmarks in each of the plurality of camera views; performing triangulation to reconstruct a three-dimensional location of each predicted landmark based on the predicted two-dimensional location of the skeletal landmarks and the camera calibration information, where the triangulation includes: for each video frame in each of the plurality of camera views: selecting one or more pairs of two-dimensional skeletal landmarks; for each selected pair of the one or more pairs of two-dimensional skeletal landmarks: computing one or more three-dimensional rays originating at a source camera for each of the two-dimensional skeletal landmarks using the intrinsic parameters and the extrinsic parameters of the source camera; locating a nearest point to each of the one or more three-dimensional rays for each of the one or more pairs of two-dimensional skeletal landmarks to obtain one or more candidate three-dimensional locations for each of the two-dimensional skeletal landmarks; calculating a first number of inliers and a second number of outliers for each of the one or more candidate three-dimensional locations; selecting a best candidate location of the one or more candidate three-dimensional locations that minimizes the second number of the outliers; and projecting the best candidate location into each of the plurality of camera views to derive a horse rectangular region of interest on a following frame for each of the plurality of camera views; regionally scaling a musculoskeletal model using the three-dimensional location of each predicted landmark; and performing inverse kinematics on the musculoskeletal model to produce kinematic trajectories.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in one or more non-transitory computer readable storage media within the respective computing/processing device.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for markerless biomechanics of equines, the method comprising:
receiving a plurality of camera views from a plurality of markerless video cameras;
predicting a two-dimensional location of skeletal landmarks in each of the plurality of camera views;
performing triangulation to reconstruct a three-dimensional location of each predicted landmarks based on a predicted two-dimensional location of the skeletal landmarks and camera calibration information for each of the plurality of markerless video cameras;
regionally scaling a musculoskeletal model using the three-dimensional location of each of the predicted landmarks; and
performing inverse kinematics on the musculoskeletal model to produce kinematic trajectories.

2. The method of claim 1, further comprising:
calibrating the plurality of markerless video cameras to create the camera calibration information for each of the plurality of markerless video cameras, wherein the camera calibration information includes at least one of intrinsic parameters and extrinsic parameters.

3. The method of claim 2, wherein:
the intrinsic parameters of each of the plurality of markerless video cameras include at least one of an intrinsic matrix (K) and a distortion coefficients (d); and
the extrinsic parameters of each of the plurality of markerless video cameras include at least one of a rotation matrix (R) and a translation vector (t).

4. The method of claim 1, wherein predicting the two-dimensional location of the skeletal landmarks in each of the plurality of camera views uses a convolutional neural network (CNN).

5. The method of claim 1, wherein performing the triangulation to reconstruct the three-dimensional location of each of the predicted landmarks based on the predicted two-dimensional location of the skeletal landmarks and the camera calibration information for each of the plurality of markerless video cameras comprises:
selecting two-dimensional points from different camera views of the of the plurality of camera views;
measuring an error between a resulting three-dimensional point and the two-dimensional point; and
selecting the two-dimensional point and the three-dimensional point having a lowest error.

6. The method of claim 2, wherein the triangulation is performed using a random sample consensus (RANSAC) algorithm.

7. The method of claim 6, wherein the RANSAC algorithm comprises:
for each video frame in each of the plurality of camera views:
selecting one or more pairs of two-dimensional skeletal landmarks;
for each selected pair of the one or more pairs of two-dimensional skeletal landmarks:
computing one or more three-dimensional rays originating at a source camera for each of the two-dimensional skeletal landmarks using the intrinsic parameters and the extrinsic parameters of the source camera;
locating a nearest point to each of the one or more three-dimensional rays for each of the one or more pairs of two-dimensional skeletal landmarks to obtain one or more candidate three-dimensional locations for each of the two-dimensional skeletal landmarks;
calculating a first number of inliers and a second number of outliers for each of the one or more candidate three-dimensional locations;
selecting a best candidate location of the one or more candidate three-dimensional locations that minimizes the second number of the outliers; and
projecting the best candidate location into each of the plurality of camera views to derive a horse rectangular region of interest on a following frame for each of the plurality of camera views.

8. The method of claim 1, wherein the musculoskeletal model is regionally scaled using the three-dimensional location of one or more of the predicted landmarks.

9. The method of claim 1, wherein the inverse kinematics is performed using a software platform.

10. A system for markerless biomechanics of equines, the system comprising:
a plurality of markerless video cameras;
camera calibration circuitry;
two-dimensional landmark location circuitry;
three-dimensional triangulation circuitry;
musculoskeletal scaling circuitry;
inverse kinematics circuitry; and
a computing device, the computing device configured to:
receive a plurality of camera views from the plurality of markerless video cameras;
calibrate the plurality of markerless video cameras using the camera calibration circuitry to create camera calibration information for each of the plurality of markerless video cameras;
predict a two-dimensional location of skeletal landmarks in each of the plurality of camera views using the two-dimensional landmark location circuitry;
perform triangulation to reconstruct a three-dimensional location of each predicted landmark based on a predicted two-dimensional location of the skeletal landmarks and the camera calibration information using the three-dimensional triangulation circuitry;
regionally scale a musculoskeletal model using the three-dimensional location of each of the predicted landmarks; and
perform inverse kinematics on the musculoskeletal model to produce kinematic trajectories.

11. The system of claim 10, wherein the camera calibration circuitry is configured to:
determine intrinsic parameters of each of the plurality of markerless video cameras; and
determine extrinsic parameters of each of the plurality of markerless video cameras.

12. The system of claim 11, wherein the intrinsic parameters of each of the plurality of markerless video cameras include at least one of an intrinsic matrix (K) and a distortion coefficients (d).

13. The system of claim 11, wherein the extrinsic parameters of each of the plurality of markerless video cameras include at least one of a rotation matrix (R) and a translation vector (t).

14. The system of claim 10, wherein the two-dimensional landmark location circuitry further comprises:
convolutional neural network (CNN) circuitry.

15. The system of claim 11, wherein the three-dimensional triangulation circuitry further comprises:
a random sample consensus (RANSAC) algorithm.

16. The system of claim 15, wherein the RANSAC algorithm configured to:
for each video frame in each of the plurality of camera views:
select one or more pairs of two-dimensional skeletal landmarks;
for each selected pair of the one or more pairs of two-dimensional skeletal landmarks:
compute one or more three-dimensional rays originating at a source camera for each of the two-dimensional skeletal landmarks using the intrinsic parameters and the extrinsic parameters of the source camera;
locate a nearest point to each of the one or more three-dimensional rays for each of the one or more pairs of two-dimensional skeletal landmarks to obtain one or more candidate three-dimensional locations for each of the two-dimensional skeletal landmarks;
calculate a first number of inliers and a second number of outliers for each of the one or more candidate three-dimensional locations;
select a best candidate location of the one or more candidate three-dimensional locations that minimizes the second number of the outliers; and
project the best candidate location into each of the plurality of camera views to derive a horse rectangular region of interest on a following frame for each of the plurality of camera views.

17. The system of claim 10, wherein the musculoskeletal model is regionally scaled using the three-dimensional location of the predicted landmarks.

18. The system of claim 10, wherein the computing device further configured to:
perform the inverse kinematics using a software platform.

19. A method for markerless biomechanics of equines, the method comprising:
receiving a plurality of camera views from a plurality of markerless video cameras;
calibrating the plurality of markerless video cameras to create camera calibration information for each of the plurality of markerless video cameras, wherein the camera calibration information includes at least one of intrinsic parameters and extrinsic parameters;
predicting a two-dimensional location of skeletal landmarks in each of the plurality of camera views;
performing triangulation to reconstruct a three-dimensional location of each predicted landmark based on a predicted two-dimensional location of the skeletal landmarks and the camera calibration information, wherein the triangulation comprises:
for each video frame in each of the plurality of camera views:
selecting one or more pairs of two-dimensional skeletal landmarks;
for each selected pair of the one or more pairs of two-dimensional skeletal landmarks:
computing one or more three-dimensional rays originating at a source camera for each two-dimensional skeletal landmark of the one or more pairs of two-dimensional skeletal landmarks using the intrinsic parameters and the extrinsic parameters of the source camera;
locating a nearest point to each of the one or more three-dimensional rays for each of the one or more pairs of two-dimensional skeletal landmarks to obtain one or more candidate three-dimensional locations for each of the two-dimensional skeletal landmarks;
calculating a first number of inliers and a second number of outliers for each of the one or more candidate three-dimensional locations;
selecting a best candidate location of the one or more candidate three-dimensional locations that minimizes the second number of the outliers; and
projecting the best candidate location into each of the plurality of camera views to derive a horse rectangular region of interest on a following frame for each of the plurality of camera views;
regionally scaling a musculoskeletal model using the three-dimensional location of each of the predicted landmarks; and
performing inverse kinematics on the musculoskeletal model to produce kinematic trajectories.

20. The method of claim 19, wherein predicting the two-dimensional location of the skeletal landmarks in each of the plurality of camera views uses a convolutional neural network (CNN).
